(19) United States
(12) Patent Application Publication
(10) Pub. No.: US 2016/0283671 A1
(43) Pub. Date: Sep. 29, 2016

(54) SCHEDULING APPARATUS, SCHEDULING METHOD AND DIAGNOSTIC SYSTEM

(71) Applicant: Siemens Aktiengesellschaft, Muenchen (DE)

(72) Inventor: Dilip BHASKAR, Erlangen (DE)

(21) Appl. No.: 14/670,548

(22) Filed: Mar. 27, 2015

(51) Int. Cl. G06F 19/00; G06Q 50/22; G06Q 10/10

(52) U.S. Cl. CPC G06F 19/327; G06Q 10/1095; G06Q 50/22

(57) ABSTRACT

A scheduling apparatus and method are provided for scheduling diagnostic devices such as computer tomography, magnetic resonance and positron emission tomography imaging systems. Information about previously performed diagnostic activities of a plurality of diagnostic devices is stored in a database. When scheduling a further diagnostic activity, information about previously performed diagnostic activities are analyzed in order to estimate the required time for a desired. In this way, the utilization of expensive diagnostic devices can be optimized.

### FIELD

The present invention relates to a scheduling apparatus for scheduling activities of a plurality of diagnostic devices, a scheduling method for scheduling activities of a plurality of diagnostic devices and a diagnostic system. In particular, the present invention relates to scheduling of diagnostic devices such as imaging systems.

### RELATED ART

In the field of medical diagnostics imaging equipment such as computer tomography (CT), magnetic resonance (MR), and positron emission tomography (PET) imaging systems are used for many diagnostic purposes. These imaging devices require much space for the device itself and the related equipment. Further, these devices are very expensive. Thus, the costs for medical diagnostics performed by such imaging devices are very high. Usually, a utilization factor of these imaging devices is about 50% (i.e. time used as a percentage of total available time of the device).

If such a utilization factor could be increased, the equipment can be used more intensely, and consequently less capacity is required for performing imaging diagnostics. However, if the number of available imaging devices is reduced, access is degraded and the capacity for performing imaging diagnostics is reduced. Consequently, patients will need to travel farther and have to accept longer delays in the waiting rooms.

When a medical diagnostic by an imaging system is requested, usually a particular device is selected. Subsequently, a rather vague time period for performing the diagnostic is taken into account and an available time period for performing the imaging diagnostic is selected manually. Since this scheduling usually is limited to a single or only a few selectable diagnostic devices, and the time period for performing the diagnostic is rather unknown, this scheduling process will lead to a rather low utilization factor of the devices, and to discomfort of the patients.

### SUMMARY

In view of the above, there is a need for an enhanced scheduling of diagnostic devices, in particular an enhanced scheduling of diagnostic imaging equipment.

At least one embodiment of the present invention provides an apparatus and a method for scheduling diagnostic devices taking into account an enhancement of the utilization factor of these devices.

At least one embodiment of the present invention provides an apparatus and a method for scheduling diagnostic devices which can reduce the number of required devices for performing desired diagnostic activities.

At least one embodiment of the present invention provides a scheduling method and apparatus for an automatic scheduling reducing the waiting time of a patient for performing a desired medical diagnostic operation.

### BRIEF DESCRIPTION OF DRAWINGS

FIG. 1: shows a schematic illustration of a diagnostic system according to an embodiment of the invention;

FIG. 2: shows a schematic illustration of a scheduling apparatus according to an embodiment; and

FIG. 3: shows a flowchart of a scheduling apparatus underlying an embodiment.

### DESCRIPTION OF EMBODIMENTS

According to a first aspect, a scheduling apparatus for scheduling activities of a plurality of diagnostic devices is provided. The scheduling apparatus comprises an activity memory for storing data relating to activities previously performed by said plurality of diagnostic devices in association with time periods required for performing the activities; a task memory for storing data relating to schedule further activities of said plurality of diagnostic devices; and a processor, coupled to said activity memory and said task memory, said processor receiving a request for a desired activity, identifying diagnostic devices for performing the desired activity, determining for each identified diagnostic device a time period required for performing the desired activity based on the data stored in said activity memory, identifying an available time period for executing the desired activity by a diagnostic device out of the plurality of diagnostic devices based on the data stored in said task memory, and storing a reservation for performing the desired activity by the diagnostic device having an available time period.

In this way, the utilization of a plurality of diagnostic devices can be easily planned and scheduled. In particular, the utilization of the plurality of diagnostic devices is managed by a central scheduling apparatus. In this way, it is possible to identify an appropriate diagnostic device for each desired activity (medical imaging). By planning the activities by such a centralized scheduling apparatus, it is possible to identify an appropriate diagnostic device. In this way, the utilization of the available diagnostic devices can be increased. Further, it is possible to identify such a device which can fit the requirements of a desired activity. In this way, the waiting time for performing the desired activity can be reduced, and the comfort for a patient is increased.

By taking into account an enhanced estimation of the time period required for previously performed activities of each available device, it is possible to perform a precise forecast of a required time period for a desired activity. In this way, the scheduling of the desired activities can be optimized. Thus, idle time or overload of the diagnostic devices can be avoided. In this way, the utilization factor of the diagnostic devices can be increased, too.

According to an implementation of the first aspect, the scheduling apparatus further comprises a terminal for entering a desired activity and forwarding the desired activity to said processor. In this way, desired activities can be easily entered for an automatic scheduling.

According to a further implementation of said first aspect, said terminal provides a plurality of predefined selectable activities. In this way, a user can be easily guided through the scheduling process. By selecting only available options of the activities, failures can be avoided and the reliability of the scheduled activities is enhanced.

According to still a further implementation of the first aspect, said activity memory is further storing costs of previously performed activities, and said processor is selecting a device for performing a desired activity based on the costs of previously perform activities, which are stored in said activity memory. In this way, it is possible to perform a cost-saving scheduling of the desired activities.

According to a further implementation of the first aspect, the scheduling apparatus further comprises a device memory for storing information specifying the plurality of diagnostic devices. For instance, this device memory may specify all available devices. Additionally, the device memory may specify all available activities and options of each of the devices.

According to a second aspect, a diagnostic system is provided. The diagnostic system comprises a scheduling apparatus according to the first aspect; and a plurality of diagnostic devices coupled to the scheduling apparatus.

According to a further implementation of the second aspect, the plurality of diagnostic devices comprises computer tomography imaging systems, magnetic resonance imaging systems and/or positron tomography imaging systems.

According to a third aspect, a scheduling method for scheduling activities of a plurality of diagnostic devices is provided. The method comprises the steps of providing an activity memory for storing data relating to activities previously performed by said plurality of diagnostic devices in association with time periods required for performing the activities, and a task memory for storing data relating to scheduled further activities of said plurality of diagnostic devices; receiving a request for a desired activity; identifying diagnostic devices for performing the desired activity out of the plurality of diagnostic devices; determining for each identified diagnostic device a time period required for performing the desired activity based on the data stored in said activity memory; identifying an available time period for executing the desired activity by a diagnostic device out of the plurality of diagnostic devices based on the data stored in said task memory; and storing a reservation for performing the desired activity by the diagnostic device having an available time period.

According to a further implementation of the third aspect, the step of receiving a request for a desired activity comprises the steps of providing a plurality of selectable options and receiving a user input indicating a selection of at least one of the provided selectable options.

According to a further implementation of the third aspect, the receiving step is receiving an identification of a predefined part of a body.

According to still a further implementation of the third aspect, the activities comprise an activity performed by a computer tomography, magnetic resonance and/or positron tomography imaging system.

According to a further implementation of the third aspect, the method comprises a step of sending a notification, wherein the notification specifies the reservation for performing the desired activity.

According to a further implementation of the third aspect, the notification comprises information specifying a device and a time for performing the desired activity.

According to a fourth aspect, a recording medium is provided, comprising a computer program product for performing a method of the third aspect.

Further implementations and advantages of the present invention will become apparent by the following description of embodiments in connection with the accompanying drawings, wherein:

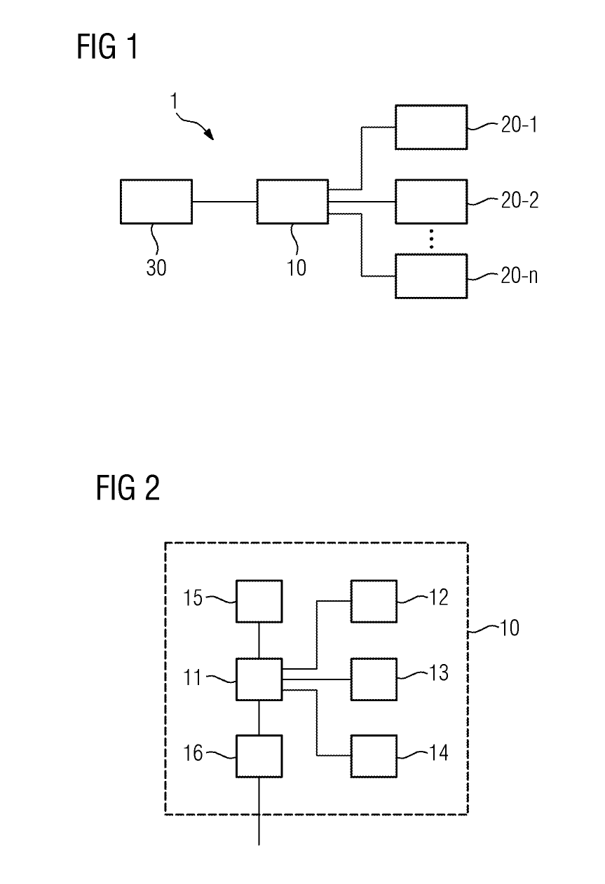

FIG. 1 shows a schematic illustration of a diagnostic system 1. The diagnostic system 1 may comprise a scheduling apparatus 10 and a plurality of diagnostic devices 20-i. The diagnostic devices 20-i are coupled to scheduling apparatus 10. The diagnostic devices may be any kind of diagnostic devices. In particular, the diagnostic devices 20-i may be diagnostic imaging devices. For instance, the diagnostic devices 20-i may be computer tomography, magnetic resonance and/or positron emission tomography imaging systems. However, any other kind of diagnostic system, in particular medical diagnostic system, such as imaging scanners, may be possible, too. The diagnostic devices 20-i are coupled to scheduling apparatus 10 for data exchange. In this way, data relating to an activity performed by diagnostic device 20-i can be send from diagnostic device 20-i to scheduling apparatus 10. In this way, any kind of information about previously performed activities of diagnostic device 20-i can be provided to scheduling apparatus 10. For instance, a log file of diagnostic device 20-i can be sent to scheduling apparatus 10. The data, for instance the log file, can be sent from diagnostic device 20-i to scheduling apparatus 10 after each activity performed by diagnostic device 20-i. Alternatively, it is also possible to send all data of previously performed activities at a predetermined time. For instance, the log file comprising the data about previously performed activities can be sent once a day.

In order to perform a scheduling of the activities of the related diagnostic devices 20-i, scheduling apparatus 10 may comprise an internal terminal. Additionally or alternatively, scheduling apparatus 10 may be connected to one or a plurality of external terminals 30. For instance, scheduling apparatus 10 may be connected to these external terminals 30 by an internet connection. In order to enhance the security, a virtual private network (VPN) connection may be established between scheduling apparatus 10 and the external terminals 30. For instance, scheduling apparatus 10 may comprise a web-server and external terminals 30 may run a corresponding browser application.

FIG. 2 shows a schematic illustration of scheduling apparatus 10. Scheduling apparatus 10 may comprise interfaces 16 in order to connect the scheduling apparatus 10 with diagnostic devices 20-i and/or external terminals 30. Further, scheduling apparatus 10 comprises an activity memory 12 for a storing data relating to activities previously performed by the diagnostic devices 20-i. This data may be the data received from the diagnostic devices 20-i. For instance, the log files sent from diagnostic devices 20-i may be stored in activity memory 12. In particular, the previously performed activities of the related diagnostic devices 20-i are stored in activity memory 12 in association with the time period required for the respective activities. In this way, it is possible to make an estimation of a required time period for a particular activity performed by the respective diagnostic device 20-i. Additional, it may be also possible to store further information related with a respective activity in this activity memory 12. For instance, it may be also possible to determine the costs of a particular activity performed by the respective diagnostic device.

In the following, the data stored in activity memory 12 are explained in more detail. For instance, activity memory 12 may store for each entry an identification of the respective diagnostic device 20-i. For instance, a unique identifier of the respective diagnostic device 20-i may be used in order to identify the diagnostic device 20-i. However, other identifiers may be possible, too. Further, a type of the activity may be specified in more detail. For instance, it may be specified whether the activity relates to a particular scanner type. Such a scanner type may be a computer tomography, magnetic resonance, or positron emission tomography imaging. Other scanner types are possible, too. Further to this, the activity may be specified in more detail. In particular, it can be specified which part of the body of a patient has been scanned. For instance, it can be specified whether a hand, a leg, a particular part of a leg or an arm, the torso, the backbone, a particular organ, etc. has been scanned by the respective diagnostic device. Any further additional parameters specifying the diagnostic activity may be also specified. Further to this, the respective time period for performing this activity is also specified in each entry relating to an activity. For instance, the time period in minutes or seconds may be specified. Additionally or alternatively, it may be also specified a time stamp of the beginning and the ending of an activity. Any further information associated with the respective activity can be added to an entry in the activity memory 12. For example, it is possible to specify the costs of the activity or particular feature, for instance, information about the patient (weight, size, sex, age, etc.).

Scheduling apparatus 10 further comprises a task memory 13 for storing data relating to scheduled further activities of the plurality of diagnostic devices 20-i. For instance, task memory 13 may comprise a database storing for each diagnostic device 20-i associated with scheduling apparatus 10 a timetable. Successive activities of the respective diagnostic devices 20-i may be stored in this timetable. For example, it may be possible to specify for each day and for each time period whether or not the respective diagnostic device 20-i is available or a diagnostic activity is planned. In this way, the occupied/available time periods of each diagnostic device 20-i can be specified. For this purpose, task memory 13 may just comprise an entry whether the respective diagnostic device 20-i is available or not. Further to this, it is also possible to specify for each entry in task memory 13 the scheduled activity which has been planned for the respective diagnostic device 20-i. For this purpose, information about the planned activity and/or about the person which has to be examined by the respective diagnostic device 20-i can be stored in task memory 13. However, it is also possible to store only a unique identifier in task memory 13 without any personal data relating to the person to be examined.

Further, scheduling apparatus 10 may comprise a device memory 14 for storing information specifying the plurality of diagnostic devices 20-i. For instance, this device memory 14 may comprise entries specifying the respective diagnostic devices 20-i by the scanning activities which can be performed by the respective diagnostic devices 20-i. Additional, the location of the respective diagnostic devices 20-i may be stored in this device memory 14. For instance, an address, a number of a building, a room number, etc. may be specified. Further relevant information, for instance a maximum size of a person to be scanned by the respective diagnostic device 20-i, a maximum weight or other limitations may be also stored in this device memory 14. Any further information specifying the respective diagnostic device 20-i can be stored in device memory 14, too.

Scheduling apparatus 10 further comprises a processor 11 which is coupled to the activity memory 12 and the task memory 13. Processor 10 may be also coupled to device memory 14. Processor 11 may receive a request for a further desired activity. This further desired activity may be input by an internal terminal 15 of scheduling apparatus 10. Alternatively, it is also possible to provide a request for such a further desired activity by an external terminal 30. This request for a further activity may specify the desired further activity by a type of diagnosis, for instance computer tomography, magnetic resonance or positron emission tomography imaging. Further available diagnostic activities may be possible, too. Additionally, the request may specify the desired activity in more detail. For this purpose, a part of the body of a person may be specified. For instance, it may be specified whether the torso, an arm, a leg or a part of an arm or a leg or a particular organ has to be scanned by the desired activity. Further additional information about the person to be scanned may be also possible. For instance, the weight, the size and/or particular limitations may be entered. In order to simplify the input of the desired activity, internal terminal 15 or external terminal 30 may provide a plurality of options to a user, and the user may select the appropriate options. Further limitations for a particular region, for instance only diagnostic devices in a radius of 50 km, can be specified, too.

Based on the information about the desired activity, processor 11 identifies one or more diagnostic devices for performing the desired activity. For this purpose, processor 11 may refer to device memory 14 and/or activity memory 12. Processor 11 may compare the features of the desired activity with the available features of the available diagnostic devices 20-i. After one or a plurality of appropriate diagnostic devices 20-i have been identified, processor 11 refers to activity memory 11 in order to identify previous activities of the respective devices 20-i. If one or more of similar previous activities for the respective diagnostic devices 20-i have been found in activity memory 12, processor 11 refers to these entries in order to estimate or determine the required time period for such an activity. Further to this, additional information about the respective activity performed by the corresponding diagnostic device 20-i can be also extracted from the entries in activity memory 12. For instance, the costs or additional features or limitations may be identified based on the entries of corresponding previous activities stored in activity memory 12.

After one or a plurality of appropriate diagnostic devices 20-i have been identified and for each of these devices 20-i further parameters, in particular the required time period for performing the desired activity, have been determined, processor 11 refers to task memory 13 in order to identify an available time period for executing the desired activity. For example, it may be possible to analyze the data stored in task memory 13 in order to identify a diagnostic device 20-i which can perform the desired activity at the earliest time. However, further constraints may be considered for scheduling the desired activity, too. For example, costs for performing the desired activity, a distance between the location of the person to be scanned by the device 20-i and the location of the diagnostic device 20-i and/or further constraints may be considered. For example, the individual constraint may be weighted, and an optimum diagnostic device 20-i may be determined based on a predetermined algorithm taking into account all these constraints.

After an appropriate diagnostic device 20-i for performing the desired activity has been identified, processor 11 creates a reservation and stores this reservation for the selected diagnostic device 20-i in activity memory 13. After this reservation has been stored in task memory 13, the respective time period for performing the desired activity is blocked in activity memory 13.

Finally, the result of a reservation may be output to the user and/or the person to be scanned by the respective diagnostic device 20-i. For example, the information about the reservation may be displayed on the internal terminal 15 or the external terminal 30. Further to this, it may be also possible to print information about the reservation or to send an email or a SMS comprising all relevant information about the reservation. For example, this information may comprise date, time, location (address, room number) and activity to be performed.

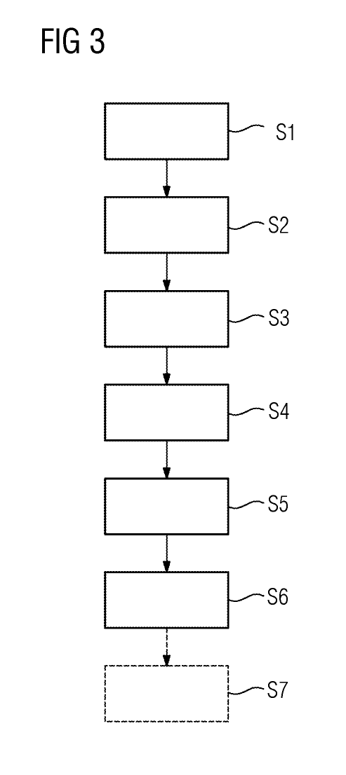

FIG. 3 shows a schematic diagram of a flowchart of a scheduling method. This scheduling method may be performed, for instance, by the above outlined scheduling apparatus 10.

In a first step S1 of a scheduling method for scheduling activities of a plurality of diagnostic devices 20-i an activity memory 12 for storing data relating to activities previously performed by said plurality of devices 20-i in association with time periods required for performing the activities and a task memory 13 for storing data relating to scheduled further activities of said plurality of devices 20-i are provided. In order to schedule a further activity, a request for a desired activity is received in step S2. For this purpose the desired activity may be specified as already outlined above in connection with scheduling apparatus 10. In particular, the specification of the desired activity may be performed by providing a plurality of selectable options and receiving a user input indicating a selection of at least one of the provided selectable options.

After a request for a desired activity has been received, one or a plurality of devices is identified in step S3 for performing the desired activity. As already outlined above in connection with the scheduling apparatus, this identification may be performed by referring to a device memory 14 specifying all of the available diagnostic devices 20-i, and/or by referring to activity memory 12 storing information about previous diagnostic activities of the associated diagnostic devices 20-i.

If at least one device for performing the desired activity has been identified, step S4 estimates or determines for each identified device a time period required for performing the desired activity. This determination of the respective time period is performed based on an analysis of the data about previously performed activities stored in activity memory 12.

Subsequently, in step S5 an available time period for executing the desired activity by a device out of the plurality of diagnostic devices 20-i is identified based on the data stored in task memory 13. As already outlined above, further constraints taking into account costs, location of the respective diagnostic device and/or limitations for weight, size, etc. may be considered for identifying an appropriate diagnostic device, too.

After an appropriate diagnostic device 20-i has been identified and selected, a respective reservation for this identified diagnostic device 20-i is stored in task memory 13 in step S6.

Optionally, in step S7, information about the reservation may be sent. This information about the reservation may be sent to the person to be scanned by the respective diagnostic device, an operator and/or further persons related with this desired activity.

The above outlined tasks for performing a scheduling by a scheduling apparatus 10 and the corresponding scheduling method may be performed automatically. In other words, after entering all parameters of a desired activity and further constraints which have to be considered, the scheduling of the desired activity is performed automatically and as a result, the respective information about the reservation is output. However, it may be further possible that a user may enter further options and/or constraints during the scheduling process. For instance, the scheduling of the desired activity may be interrupted after a plurality of appropriate diagnostic devices 20-i have been identified, and a user may manually select one or more of these devices before the scheduling process is proceeded.

Summarizing, the present invention relates to a scheduling apparatus and method for scheduling diagnostic devices such as computer tomography, magnetic resonance and positron emission tomography imaging systems. Information about previously performed diagnostic activities of a plurality of diagnostic devices is stored in a database. When scheduling a further diagnostic activity, information about previously performed diagnostic activities are analyzed in order to estimate the required time for a desired. In this way, the utilization of expensive diagnostic devices can be optimized.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A scheduling apparatus for scheduling activities of a plurality of diagnostic devices, comprising:
an activity memory for storing data relating to activities previously performed by said plurality of diagnostic devices in association with time periods required for performing the activities;
a task memory for storing data relating to scheduled further activities of said plurality of diagnostic devices; and
a processor, coupled to said activity memory and said task memory, said processor receiving a request for a desired activity, identifying diagnostic devices for performing the desired activity, determining for each identified diagnostic device a time period required for performing the desired activity based on the data stored in said activity memory, identifying an available time period for executing the desired activity by a device out of the plurality of diagnostic devices based on the data stores in said task memory, and storing a reservation for performing the desired activity by the diagnostic device having an available time period.

2. The scheduling apparatus according to claim 1, further comprising a terminal for entering a desired activity and forwarding the desired activity to said processor.

3. The scheduling apparatus according to claim 2, wherein said terminal providing a plurality of predefined selectable activities.

4. The scheduling apparatus according to claim 1, wherein said activity memory further storing costs previously performed activities, and said processor selecting a diagnostic device for performing a desired activity based on the costs of previously performed activities, stored in said activity memory.

5. The scheduling apparatus according to claim 1, further comprising a device memory for storing information specifying the plurality of diagnostic devices.

6. A diagnostic system comprising
the scheduling apparatus of claim 1; and
a plurality of diagnostic devices coupled to said scheduling apparatus.

7. The diagnostic system according to claim 6, wherein said plurality of diagnostic devices comprising computer tomography imaging systems, magnetic resonance imaging systems and/or positron tomography imaging systems

8. A scheduling method for scheduling activities of a plurality of diagnostic devices, the method comprising the steps of:
providing an activity memory for storing data relating to activities previously performed by said plurality of diagnostic devices in association with time periods required for performing the activities, and a task memory for storing data relating to scheduled further activities of said plurality of devices;
receiving a request for a desired activity,
identifying diagnostic devices for performing the desired activity out of the plurality of devices,
determining for each identified diagnostic device a time period required for performing the desired activity based on the data stored in said activity memory,
identifying an available time period for executing the desired activity by a diagnostic device out of the plurality of diagnostic devices based on the data stored in said task memory, and
storing a reservation for performing the desired activity by the device having an available time period.

9. The method according to claim 8, wherein said step of receiving a request for a desired activity comprising the steps of providing a plurality of selectable options, and receiving a user input indicating a selection of at least one of the provided selectable options.

10. The method according to claim 8, wherein said receiving step receiving an identification of a predefined part of a body.

11. The method according to claim 8, wherein said activity comprising an examination by a computer tomography, magnetic resonance and/or positron tomography imaging system.

12. The method according to claim 8, further comprising a step of sending a notification, the notification specifying the reservation for performing the desired activity.

13. The method according to claim 12, wherein said notifications comprising information specifying a diagnostic device and a time for performing the desired activity.

14. A recording medium comprising a computer program product including program segments to, when executed by a processor, performing the method of claim 8.

15. A diagnostic system comprising
the scheduling apparatus of claim 2; and
a plurality of diagnostic devices coupled to said scheduling apparatus.

16. A diagnostic system comprising
the scheduling apparatus of claim 4; and
a plurality of diagnostic devices coupled to said scheduling apparatus.

17. A diagnostic system comprising
the scheduling apparatus of claim 5; and
a plurality of diagnostic devices coupled to said scheduling apparatus.

18. A recording medium comprising a computer program product including program segments to, when executed by a processor, performing the method of claim 9.

19. A recording medium comprising a computer program product including program segments to, when executed by a processor, performing the method of claim 10.

20. A recording medium comprising a computer program product including program segments to, when executed by a processor, performing the method of claim 11.
